(19) United States
(12) Patent Application Publication
(10) Pub. No.: US 2023/0373480 A1
(43) Pub. Date: Nov. 23, 2023

(54) VEHICLE CONTROL DEVICE, VEHICLE, VEHICLE CONTROL METHOD, AND COMPUTER-READABLE STORAGE MEDIUM

(71) Applicant: TOYOTA JIDOSHA KABUSHIKI KAISHA, Toyota-shi (JP)

(72) Inventor: Hirofumi MORI, Hadano-shi (JP)

(21) Appl. No.: 18/318,789

(22) Filed: May 17, 2023

(30) Foreign Application Priority Data
May 19, 2022 (JP) 2022-082419

(51) Int. Cl. B60W 30/14; B60W 40/105

(52) U.S. Cl. CPC B60W 30/143; B60W 40/105; B60W 2540/106; B60W 2554/80

(57) ABSTRACT

There is provided a vehicle control device including a reaction force control section configured to acquire a relative speed obtained by subtracting a speed of a preceding vehicle from a speed of an own-vehicle, and, in a case in which the acquired relative speed is less than a predetermined value, limit a reaction force applied to an accelerator pedal of the own-vehicle by a reaction force application section.

### CROSS-REFERENCE TO RELATED APPLICATION

This application is based on and claims priority under 35 USC § 119 from Japanese Patent Application No. 2022-082419 filed on May 19, 2022, the disclosure of which is incorporated by reference herein.

### TECHNICAL FIELD

The present disclosure relates to a vehicle control device, a vehicle, a vehicle control method, and a computer-readable storage medium.

### RELATED ART

Patent Document 1 (Japanese Patent Application Laid-Open (JP-A) No. 2003-205760 discloses technology in which a vehicle state and a travel environment of vehicle surroundings are detected, a degree of risk of an own-vehicle or own-vehicle surroundings is calculated, and a reaction force increase amount of an accelerator pedal is monotonically increased as the calculated degree of risk increases. In the technology described in Patent Document 1, the degree of risk is calculated based on a margin time indicating a time until the own-vehicle will catch up with a preceding vehicle, and an inter-vehicle time indicating a time until the own-vehicle will reach a current position of the preceding vehicle.

However, in the technology described in Patent Document 1, there is a possibility that a reaction force will be applied to the accelerator pedal even in situations in which a driver of the own-vehicle wishes to accelerate the own-vehicle, such as, for example, in situations in which a relative speed obtained by subtracting a speed of the preceding vehicle from a speed of the own-vehicle is less than a predetermined value. For this reason, there is room for improvement in order to perform driving assistance without hindering driving.

### SUMMARY

The present disclosure has been made in consideration of the above facts, and an object thereof is to provide a vehicle control device, a vehicle, a vehicle control method, and a vehicle control program capable of performing driving assistance without hindering driving.

A vehicle control device according to a first aspect includes a reaction force control section configured to acquire a relative speed obtained by subtracting a speed of a preceding vehicle from a speed of an own-vehicle, and, in a case in which the acquired relative speed is less than a predetermined value, limit a reaction force applied to an accelerator pedal of the own-vehicle by a reaction force application section.

In the first aspect, in a case in which the relative speed obtained by subtracting the speed of the preceding vehicle from the speed of the own-vehicle is less than the predetermined value, the reaction force applied to the accelerator pedal of the own-vehicle is limited. As a result, the reaction force applied to the accelerator pedal is limited in a situation in which the relative speed is less than the predetermined value, that is to say, in a situation in which a driver of the own-vehicle wishes to accelerate the own-vehicle, and therefore, it is possible to carry out driving assistance without hindering driving.

A second aspect is the first aspect, wherein the reaction force control section is configured to reduce a reaction force applied to the accelerator pedal of the own-vehicle in a case in which the relative speed is less than the predetermined value, compared to a reaction force applied to the accelerator pedal of the own-vehicle in a case in which the relative speed is equal to or greater than the predetermined value.

In the second aspect, limiting of the reaction force applied to the accelerator pedal of the own-vehicle is implemented by the following processing. Namely, the reaction force applied to the accelerator pedal of the own-vehicle in a case in which the relative speed is less than the predetermined value is reduced compared to the reaction force applied to the accelerator pedal of the own-vehicle in a case in which the relative speed is equal to or greater than the predetermined value. As a result, it is possible to carry out driving assistance while more reliably suppressing hindrance of driving.

A third aspect is the first aspect or the second aspect, wherein the predetermined value is a value at which the relative speed is greater than 0.

In a situation in which the own-vehicle is traveling behind the preceding vehicle, the driver of the own-vehicle drives while predicting the relative speed with respect to the preceding vehicle, and even in a case in which the relative speed is greater than 0, the driver will perform a driving operation of depressing the accelerator pedal of the own-vehicle if acceleration of the preceding vehicle is predicted. Based on this, in the third aspect, the predetermined value is set to a value at which the relative speed is greater than 0, and therefore, hindrance of driving can be suppressed more reliably.

A fourth aspect is the first aspect, wherein the reaction force control section is configured to determine a limit value of the reaction force applied to the accelerator pedal of the own-vehicle based on the relative speed.

In a situation in which the relative speed is less than the predetermined value, the degree to which the driver of the own-vehicle wishes to accelerate the own-vehicle varies according to the relative speed. Based on this, in the fourth aspect, the limit value of the reaction force applied to the accelerator pedal of the own-vehicle is determined based on the relative speed. As a result, the limit value of the reaction force applied to the accelerator pedal of the own-vehicle can be changed according to the degree to which the driver of the own-vehicle wishes to accelerate the own-vehicle.

A fifth aspect is the fourth aspect, wherein the reaction force control section is configured to determine the limit value of the reaction force so as to reduce the reaction force applied to the accelerator pedal of the own-vehicle as the relative speed decreases.

In a situation in which the relative speed is less than the predetermined value, the degree to which the driver of the own-vehicle wishes to accelerate the own-vehicle increases as the relative speed decreases. Based on this, in the fifth aspect, the limit value of the reaction force is determined so as to reduce the reaction force applied to the accelerator pedal of the own-vehicle as the relative speed decreases. As a result, the limit value of the reaction force applied to the accelerator pedal of the own-vehicle can be changed according to the degree to which the driver of the own-vehicle wishes to accelerate the own-vehicle.

A vehicle according to a sixth aspect includes the reaction force application section and the vehicle control device according to the first aspect.

Since the sixth aspect includes the vehicle control device according to the first aspect, it is possible to carry out driving assistance without hindering driving, similarly to the first aspect.

A vehicle control method according to a seventh aspect performs processing by a computer, in which the processing includes: acquiring a relative speed obtained by subtracting a speed of a preceding vehicle from a speed of an own-vehicle; and, in a case in which the acquired relative speed is less than a predetermined value, limiting a reaction force applied to an accelerator pedal of the own-vehicle by a reaction force application section.

According to the seventh aspect, it is possible to carry out driving assistance without hindering driving, similarly to the first aspect.

A vehicle control program according to an eighth aspect is executable by a computer to perform processing including: acquiring a relative speed obtained by subtracting a speed of a preceding vehicle from a speed of an own-vehicle; and, in a case in which the acquired relative speed is less than a predetermined value, limiting a reaction force applied to an accelerator pedal of the own-vehicle by a reaction force application section.

According to the eighth aspect, it is possible to carry out driving assistance without hindering driving, similarly to the first aspect.

### Effect of the Invention

The present disclosure has an advantageous effect of enabling driving assistance to be carried out without hindering driving.

### BRIEF DESCRIPTION OF THE DRAWINGS

FIG. 1 is a block diagram illustrating a schematic configuration of an onboard system according to an exemplary embodiment.

FIG. 2 is a functional block diagram of a haptic pedal control ECU.

FIG. 3 is a functional block diagram illustrating a relationship between a first control section and a second control section.

FIG. 4 is a line graph illustrating a relationship between a relative speed and a reaction force instruction gain in a first exemplary embodiment.

FIG. 5 is a flowchart illustrating haptic pedal control processing.

FIG. 6 is an illustrative diagram illustrating an example of a result of control performed by haptic pedal control processing.

FIG. 7 is a line graph illustrating a relationship between a relative speed and a reaction force instruction gain in a second exemplary embodiment.

### DETAILED DESCRIPTION

An example of an exemplary embodiment of the present disclosure will be described below in detail with reference to the drawings.

### First Exemplary Embodiment

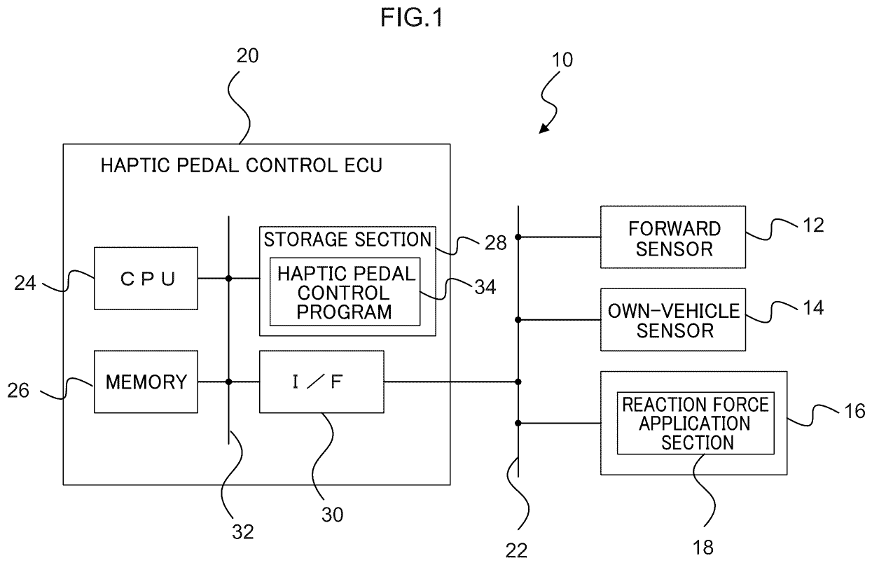

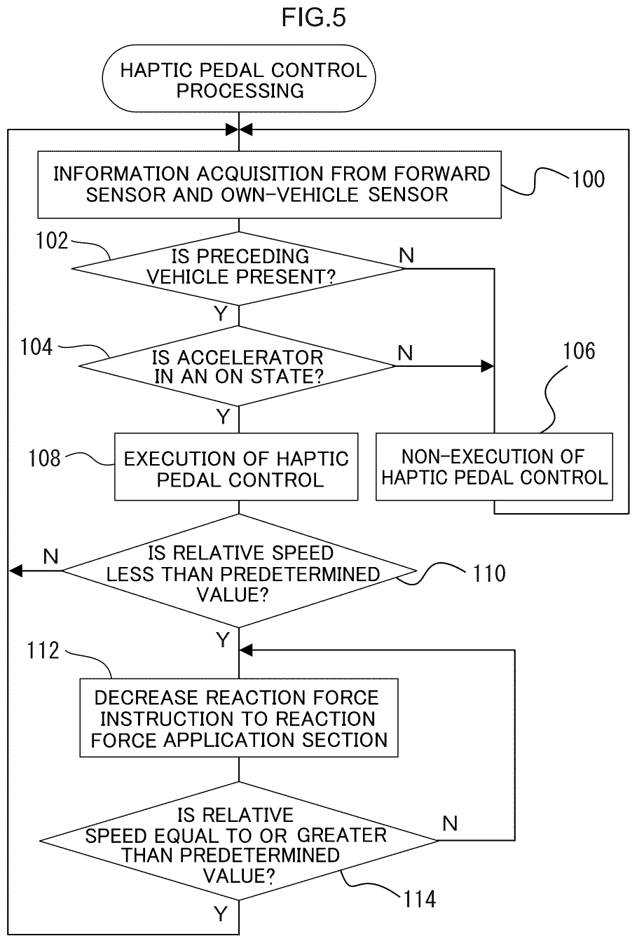

FIG. 1 illustrates an onboard system 10 according to an exemplary embodiment. The onboard system 10 is installed at a vehicle V1 (refer to FIG. 5), and includes a forward sensor 12, an own-vehicle sensor 14, an accelerator pedal 16 provided with a reaction force application section 18, and a haptic pedal control ECU 20. The forward sensor 12, the own-vehicle sensor 14, the accelerator pedal 16, and the haptic pedal control ECU 20 are each connected to a system bus 22, and are configured so as to be capable of communicating with each other.

It should be noted that, hereafter, the vehicle V1 at which the onboard system 10 is installed is referred to as an “own-vehicle V1”. The own-vehicle V1 is an example of a vehicle according to the present disclosure. Further, the haptic pedal control ECU 20 is an example of a vehicle control device according to the present disclosure.

The forward sensor 12 is a sensor that is capable of detecting an obstacle that is present ahead of the own-vehicle V1, and includes, for example, at least one of a camera, radar, LIDAR (Light Detection and Ranging, or Laser Imaging Detection and Ranging), or the like. In the present exemplary embodiment, the forward sensor 12 detects presence or absence of a preceding vehicle V2 (refer to FIG. 5) traveling ahead of the own-vehicle V1, and, in a case in which the preceding vehicle V2 has been detected, also detects a speed and an acceleration of the preceding vehicle V2, and an inter-vehicle distance between the own-vehicle V1 and the preceding vehicle V2. The presence or absence of the preceding vehicle V2, and the speed, the acceleration, and the inter-vehicle distance of the preceding vehicle V2 in a case in which the preceding vehicle V2 is present, which have been detected by the forward sensor 12, are output to the haptic pedal control ECU 20.

The own-vehicle sensor 14 includes a vehicle speed sensor that detects a speed of the own-vehicle V1 and an acceleration sensor that detects an acceleration of the own-vehicle V1. The vehicle speed and the acceleration of the own-vehicle V1, which have been detected by the own-vehicle sensor 14, are output to the haptic pedal control ECU 20.

The accelerator pedal 16 is disposed at a lower portion of a driver's seat of the own-vehicle V1. When the accelerator pedal 16 is depressed by a driver, the own-vehicle V1 generates a propulsive force that propels the own-vehicle V1, according to a depression amount thereof.

The reaction force application section 18 provided at the accelerator pedal 16 is a mechanism that is capable of applying a reaction force to the accelerator pedal 16, and includes, for example, a servo motor connected to the accelerator pedal 16. In the present exemplary embodiment, the haptic pedal control ECU 20 outputs a reaction force instruction signal corresponding to a magnitude of the reaction force to be applied by the reaction force application section 18 to the accelerator pedal 16. The reaction force application section 18 applies a reaction force corresponding to the input reaction force instruction signal to the accelerator pedal 16 by using the servo motor to generate torque corresponding to the magnitude of the reaction force represented by the reaction force instruction signal that has been input from the haptic pedal control ECU 20.

Further, the reaction force application section 18 includes a stroke sensor that is incorporated into the servo motor and detects the depression amount of the accelerator pedal 16. The depression amount of the accelerator pedal 16 that has been detected by the stroke sensor of the reaction force application section 18 is output to the haptic pedal control ECU 20.

The haptic pedal control ECU 20 includes a central processing unit (CPU) 24, a memory 26 such as read only memory (ROM), a random access memory (RAM), or the like, a non-volatile storage section 28 such as a hard disk drive (HDD), a solid state drive (SSD), or the like, and an interface (I/F) section 30. The CPU 24, the memory 26, the storage section 28, and the I/F section 30 are each connected to an internal bus 32, and are configured so as to be capable of communicating with each other. Further, the I/F section 30 is also connected to the system bus 22.

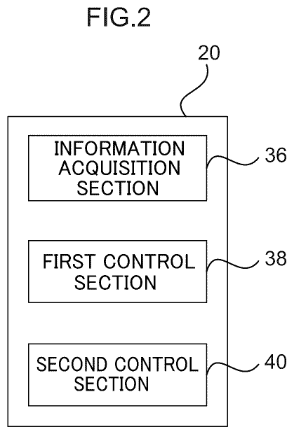

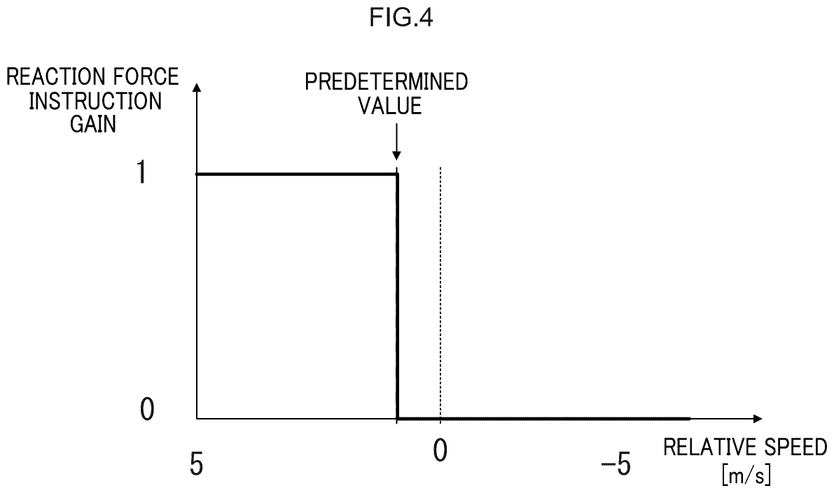

A haptic pedal control program 34 is stored in the storage section 28 of the haptic pedal control ECU 20. Due to the haptic pedal control program 34 being read out from the storage section 28 and expanded in the memory 26, and the haptic pedal control program 34 that has been expanded in the memory 26 being executed by the CPU 24, the haptic pedal control ECU 20 functions as an information acquisition section 36, a first control section 38, and a second control section 40 illustrated in FIG. 2, and carries out haptic pedal control processing (FIG. 4), which is described later. It should be noted that the haptic pedal control program 34 is an example of a vehicle control program according to the present disclosure.

The information acquisition section 36 acquires, from the forward sensor 12, the presence or absence of the preceding vehicle V2, and the speed, the acceleration, and the inter-vehicle distance of the preceding vehicle V2, and also acquires, from the own-vehicle sensor 14, the vehicle speed and the acceleration of the own-vehicle V1. Further, the information acquisition section 36 acquires the depression amount of the accelerator pedal 16 from the reaction force application section 18.

In a case in which the preceding vehicle V2 is present and the accelerator pedal 16 is depressed, the first control section 38 carries out haptic pedal control to control a reaction force that is applied to the accelerator pedal 16 by the reaction force application section 18. That is to say, based on the information that has been acquired by the information acquisition section 36, the first control section 38 calculates a relative speed between the own-vehicle V1 and the preceding vehicle V2, a relative acceleration between the own-vehicle V1 and the preceding vehicle V2, and the like. It should be noted that, in the present exemplary embodiment, the relative speed between the own-vehicle V1 and the preceding vehicle V2 means a relative speed obtained by subtracting the speed of the preceding vehicle V2 from the speed of the own-vehicle V1.

Further, based on information such as the speed of the own-vehicle V1, the relative speed, the relative acceleration, and the inter-vehicle distance between the own-vehicle V1 and the preceding vehicle V2, and the like, the first control section 38 calculates a risk value indicating a likelihood of the own-vehicle V1 colliding with the preceding vehicle V2 (also refer to the following equation (1)).

Risk value=f(speed of own-vehicle,relative speed,relative acceleration,inter-vehicle distance, . . . ) Equation (1):

Then, the first control section 38 generates and outputs a reaction force instruction that instructs a magnitude of the reaction force that is applied to the accelerator pedal 16 so that the reaction force applied to the accelerator pedal 16 increases as the calculated risk value increases.

The second control section 40 acquires the relative speed obtained by subtracting the speed of the preceding vehicle V2 from the speed of the own-vehicle V1 based on the information acquired by the information acquisition section 36, and, in a case in which the acquired relative speed is less than a predetermined value, carries out reaction force limitation control so as to limit the reaction force applied to the accelerator pedal 16 of the own-vehicle V1 by the reaction force application section 18.

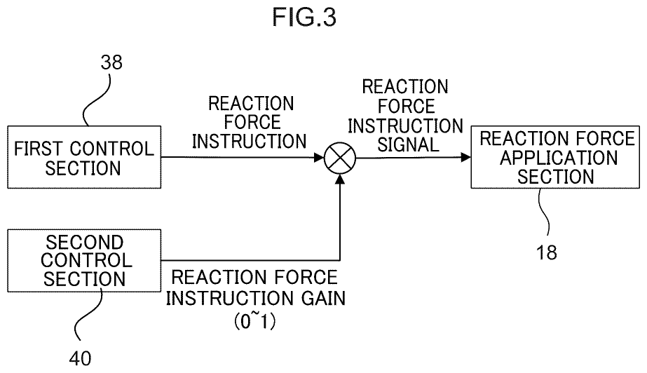

As illustrated in FIG. 3, in the present exemplary embodiment, the second control section 40 outputs a reaction force instruction gain that is multiplied by the reaction force instruction that has been output from the first control section 38, and a multiplication result of the reaction force instruction and the reaction force instruction gain is output from the haptic pedal control ECU 20 to the reaction force application section 18 as a reaction force instruction signal. The second control section 40 realizes limiting (reducing) of the reaction force applied to the accelerator pedal 16 of the own-vehicle V1 by setting the output reaction force instruction gain to a value that is smaller than 1.

Further, the second control section 40 decreases a reaction force applied to the accelerator pedal 16 of the own-vehicle V1 in a case in which the relative speed is less than the predetermined value, compared to a reaction force applied to the accelerator pedal 16 of the own-vehicle V1 in a case in which the relative speed is equal to or greater than the predetermined value. As an example, in the first exemplary embodiment, as illustrated in FIG. 4, the second control section 40 sets the reaction force instruction gain to 1 in a case in which the relative speed is equal to or greater than the predetermined value, while setting the reaction force instruction gain to 0 in a case in which the relative speed is less than the predetermined value. It should be noted that the aforementioned predetermined value is a value at which the relative speed is larger than 0, and may be, for example, a value of about 0.2 (m/s).

Furthermore, in a case in which the relative speed has changed from equal to or greater than the predetermined value to less than the predetermined value, if the reaction force instruction gain is changed in a step-wise manner as illustrated in FIG. 4, the reaction force applied to the accelerator pedal 16 of the own-vehicle V1 will rapidly decrease, and therefore, there is a possibility of inducing an abrupt depression of the accelerator pedal 16, which is undesirable. For this reason, in a case in which the relative speed has changed from equal to or greater than the predetermined value to less than the predetermined value, in actuality, the second control section 40 gradually decreases the reaction force instruction gain such that the reaction force instruction gain becomes 0 after a predetermined period of time. It should be noted that the aforementioned predetermined period of time is, for example, a value of approximately several seconds. The second control section 40 is an example of a reaction force control section of the present disclosure.

Next, as operation of the present exemplary embodiment, haptic pedal control processing that is executed by the haptic pedal control ECU 20 while an ignition switch of the own-vehicle V1 is on will be explained with reference to FIG. 5.

At step 100 of the haptic pedal control processing, the information acquisition section 36 acquires, from the forward sensor 12, the presence or absence of the preceding vehicle V2, and the speed, the acceleration, and the inter-vehicle distance of the preceding vehicle V2, acquires the vehicle speed and the acceleration of the own-vehicle V1 from the own-vehicle sensor 14, and acquires the depression amount of the accelerator pedal 16 from the reaction force application section 18.

At step 102, based on the information indicating the presence or absence of the preceding vehicle V2 that has been acquired by the information acquisition section 36 from the forward sensor 12, the first control section 38 determines whether or not there is a preceding vehicle V2 traveling ahead of the own-vehicle V1. In a case in which the determination of step 102 is negative, the processing transitions to step 106. At step 106, the first control section 38 returns to step 100 without executing haptic pedal control.

Further, in a case in which the determination of step 102 is affirmative, the processing transitions to step 104. At step 104, the first control section 38 determines whether or not the accelerator pedal 16 of the own-vehicle V1 is in a state of being depressed, based on the depression amount of the accelerator pedal 16 that has been acquired by the information acquisition section 36 from the reaction force application section 18. In a case in which the determination of step 104 is negative, the processing transitions to step 106. At step 106, the first control section 38 returns to step 100 without executing haptic pedal control.

On the other hand, in a case in which the determination of step 104 is affirmative, the processing transitions to step 108 At step 108, the first control section 38 starts execution of haptic pedal control. That is to say, the first control section 38 calculates the risk value according to the above equation (1), based on information such as the speed of the own-vehicle V1, the relative speed, the relative acceleration, and the inter-vehicle distance between the own-vehicle V1 and the preceding vehicle V2, and the like. Then, the first control section 38 generates and outputs the reaction force instruction such that the reaction force applied to the accelerator pedal 16 increases as the calculated risk value increases.

It should be noted that the second control section 40 outputs the reaction force instruction gain of 1 while the determination of step 110, which will be described next, is negative. Accordingly, during this period, the reaction force indicated by the reaction force instruction is equal to the reaction force indicated by the reaction force instruction signal and the reaction force corresponding to the risk value that has been calculated by the first control section 38 is applied to the accelerator pedal 16 by the reaction force application section 18.

At next step 110, the second control section 40 determines whether or not the relative speed between the own-vehicle V1 and the preceding vehicle V2 is less than the predetermined value. In a case in which the determination of step 110 is negative, the processing returns to step 100, and the processing of step 100 and subsequent steps is repeated.

On the other hand, in a case in which the determination of step 110 is affirmative, the processing transitions to step 112. At step 112, the second control section 40 gradually decreases the output reaction force instruction gain such that the reaction force instruction gain becomes 0 after a predetermined period of time. As a result, the reaction force represented by the reaction force instructing signal that is output to the reaction force application section 18 is also gradually reduced so as to become 0 after a predetermined period of time.

It should be noted that, in a case in which the relative speed between the own-vehicle V1 and the preceding vehicle V2 has decreased, the risk value calculated by the first control section 38 also gradually decreases. However, as is obvious from the above equation (1), since the first control section 38 calculates the risk value using parameters other than the relative speed, it takes time until the risk value and the reaction force instruction are reduced after the relative speed has decreased, and a situation arises in which the reaction force is applied to the accelerator pedal 16 while the driver of the own-vehicle V1 wishes to accelerate the own-vehicle V1.

In contrast, in the first exemplary embodiment, when the relative speed between the own-vehicle V1 and the preceding vehicle V2 becomes less than the predetermined value, the second control section 40 carries out reaction force limitation control to immediately start decreasing the reaction force instruction gain, and sets the reaction force instruction gain to 0 over a predetermined period of time. As a result, the reaction force applied to the accelerator pedal 16 is quickly reduced in a situation in which the driver of the own-vehicle V1 wishes to accelerate the own-vehicle V1, that is to say, in a situation in which the relative speed between the own-vehicle V1 and the preceding vehicle V2 has become less than the predetermined value.

At next step 114, the second control section 40 determines whether or not the relative speed between the own-vehicle V1 and the preceding vehicle V2 has become equal to or greater than the predetermined value. In a case in which the determination of step 114 is negative, the processing returns to step 112, and steps 112 and 114 are repeated until the determination of step 114 is affirmative. Further, when the determination of step 114 is affirmative, the processing returns to step 100, and step 100 and subsequent steps are repeated.

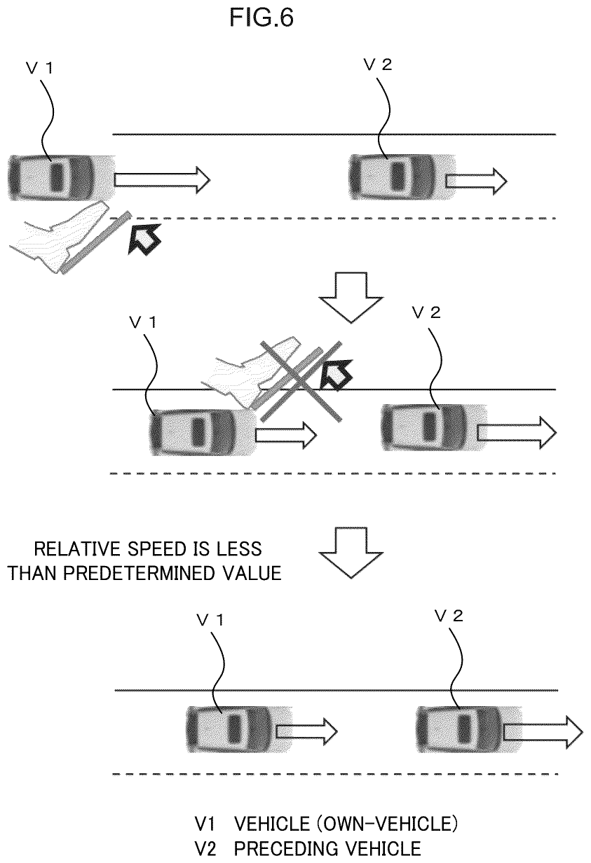

Due to the haptic pedal control processing described above, for example, the control illustrated in FIG. 6 is implemented (it should be noted that, in FIG. 6, the length of an outlined arrow represents the speed of each vehicle (the own-vehicle V1 and the preceding vehicle V2)). That is to say, as illustrated in the upper section of FIG. 6, in a situation in which the own-vehicle V1 is following the preceding vehicle V2 and the relative speed between the own-vehicle V1 and the preceding vehicle V2 is equal to or greater than the predetermined value, the haptic pedal control is carried out by the first control section 38, while the reaction force limitation control is not carried out by the second control section 40. As a result, a reaction force corresponding to the risk value is applied to the accelerator pedal 16, and excessive depressing of the accelerator pedal 16 by the driver of the own-vehicle V1 is suppressed.

Further, as illustrated in the middle section of FIG. 6, in a situation in which the preceding vehicle V2 has accelerated after the own-vehicle V1 has caught up with the preceding vehicle V2, the relative speed between the own-vehicle V1 and the preceding vehicle V2 becomes less than the predetermined value. In this situation, the haptic pedal control is carried out by the first control section 38, the reaction force limitation control is carried out by the second control section 40, and the reaction force applied to the accelerator pedal 16 is reduced from the reaction force corresponding to the risk value and is reduced to 0 after a predetermined period of time. As a result, hindrance of a driving operation, in which the accelerator pedal 16 is depressed by the driver of the own-vehicle V1, due to the reaction force applied to the accelerator pedal 16 can be suppressed, and it becomes possible for the driver to carry out acceleration as intended.

Thereafter, as illustrated in the lower section of FIG. 6, in a case in which the situation in which the relative speed between the own-vehicle V1 and the preceding vehicle V2 is less than the predetermined value is maintained, the haptic pedal control performed by the first control section 38 and the reaction force limitation control performed by the second control section 40 are continued, and the reaction force applied to the accelerator pedal 16 is maintained at 0.

As described above, in the first exemplary embodiment, the second control section 40 of the haptic pedal control ECU 20 acquires the relative speed obtained by subtracting the speed of the preceding vehicle V2 from the speed of the own-vehicle V1. Furthermore, in a case in which the acquired relative speed is less than the predetermined value, the second control section 40 limits the reaction force applied to the accelerator pedal 16 of the own-vehicle V1 by the reaction force application section 18. As a result, in a situation in which the relative speed is less than the predetermined value, that is to say, in a situation in which the driver of the own-vehicle V1 wishes to accelerate the own-vehicle, the reaction force applied to the accelerator pedal 16 is limited, and it becomes possible to carry out driving assistance without hindering driving.

Further, in the first exemplary embodiment, the second control section 40 decreases the reaction force applied to the accelerator pedal 16 of the own-vehicle V1 in a case in which the relative speed is less than the predetermined value, compared to the reaction force applied to the accelerator pedal 16 of the own-vehicle V1 in a case in which the relative speed is equal to or greater than the predetermined value. As a result, it becomes possible to carry out driving assistance while more reliably suppressing hindrance of driving.

Furthermore, in the first exemplary embodiment, the second control section 40 sets the predetermined value to a value at which the relative speed is larger than 0. As a result, hindrance of driving can be suppressed more reliably.

### Second Exemplary Embodiment

Next, a second exemplary embodiment of the present disclosure will be explained. It should be noted that, since the second exemplary embodiment has the same configuration as the first exemplary embodiment, the same reference numerals are allocated to the respective portions, and explanation of the configuration is omitted.

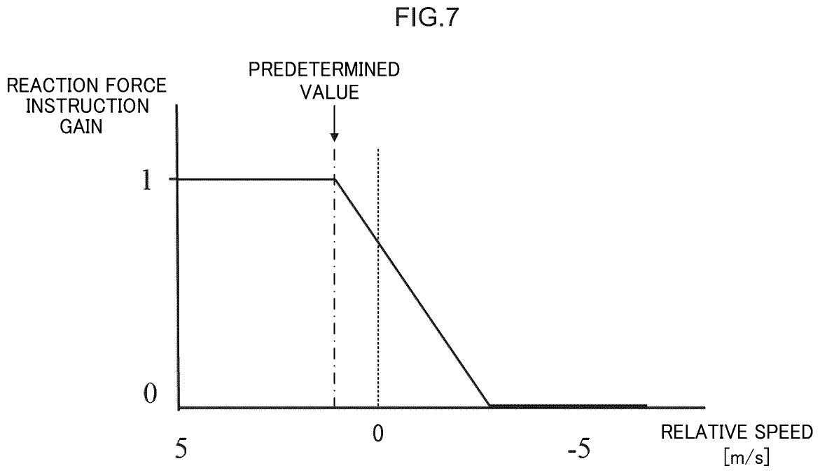

In the second exemplary embodiment, based on the relative speed between the own-vehicle V1 and the preceding vehicle V2, the second control section 40 determines a limit value (reaction force instruction gain) of the reaction force applied to the accelerator pedal 16 of the own-vehicle V1. More specifically, in the second exemplary embodiment, as illustrated in FIG. 7 as an example, the second control section 40 determines the limit value (reaction force instruction gain) of the reaction force applied to the accelerator pedal 16 of the own-vehicle V1 so as to reduce the reaction force applied to the accelerator pedal 16 of the own-vehicle V1 as the relative speed between the own-vehicle V1 and the preceding vehicle V2 decreases.

It should be noted that, in the relationship between the relative speed and the reaction force instruction gain illustrated in FIG. 7 as well, the reaction force instruction gain is 1 in a region in which the relative speed is equal to or greater than the predetermined value, while the reaction force instruction gain is smaller than 1 in a region in which the relative speed is less than the predetermined value. The predetermined value in the second exemplary embodiment is also a value at which the relative speed is larger than 0, and may be, for example, a value of about 0.2 (m/s). In the second exemplary embodiment, the relationship between the relative speed and the reaction force instruction gain illustrated in FIG. 7 is, for example, stored in advance in the storage section 28 in a form such as a map or the like.

Haptic pedal control processing according to the second exemplary embodiment will be explained below, with respect to only portions that differ from the first exemplary embodiment. At step 112 of the haptic pedal control processing according to the second exemplary embodiment, the second control section 40 reads out, from the storage section 28, the relationship between the relative speed and the reaction force instruction gain that is stored in advance in the storage section 28 in the form of a map or the like. Then, the second control section 40 identifies a value of the reaction force instruction gain corresponding to the relative speed between the own-vehicle V1 and the preceding vehicle V2 from the read-out relationship between the relative speed and the reaction force instruction gain, and outputs the reaction force instruction gain of the identified value.

Accordingly, in the second exemplary embodiment as well, when the relative speed between the own-vehicle V1 and the preceding vehicle V2 becomes less than the predetermined value, the second control section 40 carries out reaction force limitation control, and reduces the reaction force instruction gain according to the decrease in the relative speed between the own-vehicle V1 and the preceding vehicle V2. As a result, the reaction force applied to the accelerator pedal 16 is quickly reduced in a situation in which the driver of the own-vehicle V1 wishes to accelerate the own-vehicle V1, that is to say, in a situation in which the relative speed between the own-vehicle V1 and the preceding vehicle V2 has become less than the predetermined value.

As described above, in the second exemplary embodiment, the second control section 40 determines the limit value of the reaction force applied to the accelerator pedal 16 of the own-vehicle V1 based on the relative speed between the own-vehicle V1 and the preceding vehicle V2. As a result, the limit value of the reaction force applied to the accelerator pedal 16 of the own-vehicle V1 can be changed according to the degree to which the driver of the own-vehicle V1 wishes to accelerate the own-vehicle V1.

Further, in the second exemplary embodiment, the second control section 40 determines the limit value of the reaction force such that the reaction force applied to the accelerator pedal 16 of the own-vehicle V1 is reduced as the relative speed between the own-vehicle V1 and the preceding vehicle V2 decreases. As a result, the limit value of the reaction force applied to the accelerator pedal 16 of the own-vehicle V1 can be changed according to the degree to which the driver of the own-vehicle V1 wishes to accelerate the own-vehicle V1.

It should be noted that, although a configuration in which an arbitrary reaction force is applied to the accelerator pedal 16 by generating a predetermined torque with a servo motor has been explained as the reaction force application section 18 in the aforementioned exemplary embodiments, there is no limitation thereto. The reaction force application section 18 may be configured to apply a reaction force to the accelerator pedal 16 by a mechanism employing, for example, a cylinder, hydraulic pressure, or the like.

Further, although an aspect in which the haptic pedal control processing is implemented by the CPU 24 executing the haptic pedal control program 34 has been explained in the aforementioned exemplary embodiments, there is no limitation thereto, and a configuration may be provided in which a processor other than the CPU 24 executes the haptic pedal control processing. Such processors include programmable logic devices (PLD) that allow circuit configuration to be modified post-manufacture, such as a field-programmable gate array (FPGA) or the like, and dedicated electric circuits, which are processors including a circuit configuration that has been custom-designed to execute specific processing, such as an application specific integrated circuit (ASIC) or the like. Further, the haptic pedal control processing may be executed by any one of these various types of processors, or may be executed by a combination of two or more of the same type or different types of processors, for example, by plural FPGAs and a combination of a CPU and an FPGA, or the like.

Furthermore, in the aforementioned exemplary embodiments, an aspect in which the haptic pedal control program 34, which is an example of a vehicle control program according to the present disclosure, is stored (installed) in advance in the storage section 28 has been explained.

However, the vehicle control program according to the present disclosure may be provided in a format recorded on a non-transitory recording medium such as a compact disc read only memory (CD-ROM), a digital versatile disc read only memory (DVD-ROM), a universal serial bus (USB) memory or the like. Alternatively, the vehicle control program according to the present disclosure may be provided in a format that is downloaded from an external device via a network.

What is claimed is:

1. A vehicle control device comprising a reaction force control section configured to acquire a relative speed obtained by subtracting a speed of a preceding vehicle from a speed of an own-vehicle, and, in a case in which the acquired relative speed is less than a predetermined value, limit a reaction force applied to an accelerator pedal of the own-vehicle by a reaction force application section.

2. The vehicle control device according to claim 1, wherein the reaction force control section is configured to reduce a reaction force applied to the accelerator pedal of the own-vehicle in a case in which the relative speed is less than the predetermined value, compared to a reaction force applied to the accelerator pedal of the own-vehicle in a case in which the relative speed is equal to or greater than the predetermined value.

3. The vehicle control device according to claim 1, wherein the predetermined value is a value at which the relative speed is greater than 0.

4. The vehicle control device according to claim 2, wherein the predetermined value is a value at which the relative speed is greater than 0.

5. The vehicle control device according to claim 1, wherein the reaction force control section is configured to determine a limit value of the reaction force applied to the accelerator pedal of the own-vehicle based on the relative speed.

6. The vehicle control device according to claim 5, wherein the reaction force control section is configured to determine the limit value of the reaction force so as to reduce the reaction force applied to the accelerator pedal of the own-vehicle as the relative speed decreases.

7. A vehicle comprising:
the reaction force application section; and
the vehicle control device according to claim 1.

8. A vehicle control method for performing processing by a computer, the processing comprising:
acquiring a relative speed obtained by subtracting a speed of a preceding vehicle from a speed of an own-vehicle; and
in a case in which the acquired relative speed is less than a predetermined value, limiting a reaction force applied to an accelerator pedal of the own-vehicle by a reaction force application section.

9. A non-transitory computer-readable storage medium storing a vehicle control program executable by a computer to perform processing, the processing comprising:
acquiring a relative speed obtained by subtracting a speed of a preceding vehicle from a speed of an own-vehicle; and
in a case in which the acquired relative speed is less than a predetermined value, limiting a reaction force applied to an accelerator pedal of the own-vehicle by a reaction force application section.
